(19) United States
(12) Patent Application Publication
(10) Pub. No.: US 2004/0137923 A1
(43) Pub. Date: Jul. 15, 2004

(54) Short text messaging-based incoming call termination control

(76) Inventor: Alexander C. Lang, Toronto (CA)

Correspondence Address: OGILVY RENAULT, 1981 MCGILL COLLEGE AVENUE, SUITE 1600, MONTREAL, QC, H3A2Y3, CA

(21) Appl. No.: 10/751,936

(22) Filed: Jan. 7, 2004

Related U.S. Application Data
(60) Provisional application No. 60/438,311, filed on Jan. 7, 2003.

(51) Int. Cl. H04Q 7/20

(52) U.S. Cl. 455/466

(57) ABSTRACT

An incoming call routing system permits a subscriber to change a termination number associated with a dialable number at any time using a text message service. The dialable number may be a direct-inward-dial number.

### CROSS-REFERENCE TO RELATED APPLICATIONS

This application claims the benefit of priority under 35 U.S.C. 119(e) to the filing date of U.S. Provisional application No. 60/438,311, filed Jan. 7, 2003.

### MICROFICHE APPENDIX

Not Applicable.

### TECHNICAL FIELD

The invention relates to the field of control of incoming calls from a public switched telephone network, and in particular to a method and system for controlling incoming call completion using short text messages.

### BACKGROUND OF THE INVENTION

When cellular telephone users receive calls within a cell (a geographic space defined by wireless signaling strength and neighboring equipment) other than a home cell, they are said to be “roaming”. Roaming incurs charges, and in many cases, cell phone users would like to avoid those charges, without losing incoming calls.

Many current cellular telephones incorporate a short text message capability, such as Short Message Service (SMS). The use of SMS messages generally incurs a small fee per use that may be insignificant in comparison to roaming charges, especially when the roaming charges are compounded with usage charges, incoming long distance charges, etc.

While methods of redirecting and forwarding telephone calls are known in the art, such methods are used to selectively redirect or forward calls to a predetermined alternate number associated with the subscriber, such as a line termination or a voice mail system.

The use of SMS messages for mobile terminal configuration and real-time interactive selection of call treatment is also known. For example, U.S. Pat. No. 5,794,142, which issued Aug. 11, 1998 to Vanttila et al., is entitled MOBILE TERMINAL HAVING NETWORK SERVICES ACTIVATION THROUGH THE USE OF POINT-TO-POINT SHORT MESSAGE SERVICE. This patent describes a radiotelephone that includes a keypad having a plurality of keys and a display device for displaying information, including messages to a user. A method is disclosed that includes steps of transmitting a point-to-point SMS message from an operator's site through a network to the radiotelephone; receiving the SMS message from the network; interpreting the received SMS message; and activating a network service function that is specified in the received SMS message. The method includes a preliminary step of transmitting a SMS message from the radiotelephone to the operator's site, the SMS message requesting activation of the network function.

As a further example of the use of SMS in service control, U.S. Pat. No. 6,154,646, which issued on Nov. 29, 2000 to Tran et al., is entitled SYSTEM AND METHOD FOR REAL-TIME INTERACTIVE SELECTION OF CALL TREATMENT AT A RADIO TELECOMMUNICATIONS NETWORK. The patent describes a system and method for interactively selecting call treatment in real time for an incoming call in a radio telecommunications network. A modified mobile station includes a display, a browser application that presents call information regarding the incoming call and call-treatment options on a pop-up menu displayed on the display, a keypad for a user to select a call-treatment option, and a Client Access Function Teleservice (CATS) handler that packages the selected call-treatment option in an R-DATA message and sends the R-DATA message to a modified mobile switching center (MSC). The MSC determines that the R-DATA message is a CATS message from the value of the Higher Layer Protocol Identifier in the R-DATA message, and sends the call-treatment option to a modified service node in a Short Message Service message. A server in the service node receives the SMS message from the MSC, extracts the selected call-treatment option, and translates the call-treatment option into service scripts understood by the service node.

While such methods and apparatus enable improved call handling to mobile stations, they fail to provide a cost-effectively viable option for user controlled incoming call routing. There therefore exists a need for a system and method that are cost-effective and easy to use and permits telephone service subscribers to control the routing of their incoming calls.

### SUMMARY OF THE INVENTION

It is therefore an object of the invention to provide a system and a method for incoming call routing that are cost-effective, easy to use and permit telephone service subscribers to control the routing of their incoming calls.

The invention therefore provides a method for updating a termination number used by call control equipment to route incoming calls addressed to a dialable telephone number. The method comprises a first step of receiving a change of termination number message from a subscriber sent via a text message service. The message is parsed to extract the termination number, and the termination number is associated with the dialable number in a format retrievable by a switch that serves the dialable telephone number.

In one embodiment, the text message service is a Short Message Service (SMS), and the change of termination number message is an SMS message.

The method further comprises a step of verifying that the change of termination number message conforms to a predetermined format. The verifying further comprises returning an error message to the identified subscriber if the message does not conform to the predetermined format. The message is also authenticated prior to associating the termination number with the dialable number. In one embodiment, authentication comprises comparing origination station information automatically supplied by the text message service with a list of registered mobile telephone communications device identifiers. A security measure may also be included in the change of termination number message.

In one embodiment, the dialable telephone number is a direct-inward-dial (DID) number served by call control equipment operated by a service provider who provides the call termination service to the subscriber.

In one embodiment, the step of associating comprises saving the termination number in a non-volatile data storage so that the termination number is uniquely associated with the dialable number.

The invention further provides a method for changing a termination number associated with a direct-inward-dial (DID) number. The method comprises a first step of formulating a change of termination number message using a text messaging service, in accordance with a format specified by a call termination control service provider. The message identifies a termination number to which incoming calls to the DID are to be directed. The change of termination number message is sent to the service provider, which uses the message to update a table so that a query to the database using the DID number returns the termination number to which the incoming call may be directed.

The change of termination number message may comprise a Short Message Service (SMS) message.

The method further comprises selecting the termination number from among call termination devices available to receive calls at a current location of a subscriber to the service.

The invention also provides a method of permitting a Short Message Service-enabled mobile telephone user to reduce roaming charges. The method comprises a first step of providing the user with a registered direct-inward-dial (DID) number, and configuring call control equipment that is designated to serve the DID number in a public telephone network, to: receive calls addressed to the DID number; query a database to determine a current termination number associated with the DID number; and direct completion of the calls to the current termination number. The method further comprises providing a Short Message Service interface through which the user can update the database using the mobile telephone communications device.

Configuring the call control equipment comprises configuring a point of presence (POP) in the public switched telephone network by inserting into a translation table of the POP a parameter that prompts a query to obtain call completion information from the database.

In one embodiment, providing a short text message interface comprises providing a Short Message Service (SMS) gateway between the call controller and a call control signaling network.

The invention further provides a method of enabling incoming call control by a text message-enabled mobile telephone user. The method comprises steps of providing the user with a registered direct inward dial (DID) number, and configuring call control equipment that is designated to serve the DID number in a switched public telephone network, to: receive calls addressed to the DID number; query a database to determine a current termination number associated with the DID number; and direct completion of the calls to the current termination number. The method further comprises providing a message interface through which the user can update the table using the mobile telephone communications device.

In one embodiment, configuring the call control equipment comprises configuring a point of presence (POP) in the public switched telephone network by inserting into a translation table of the POP a parameter that prompts a query to retrieve the termination number from the database.

The text message interface may comprise a Short Message Service (SMS) gateway.

The invention further provides an apparatus for updating a termination number used by call control equipment that serves a direct-inward-dial (DID) number. The apparatus comprises a request processor for receiving a DID number from the call control equipment, and returning a termination number associated with the DID number, and a text messaging processor for: receiving a change of termination number message from an identified subscriber device associated with the DID number; parsing the message to extract a current termination number to be associated with the DID number; and passing the current termination number to the request processor, which associates the current termination number with the DID number.

In one embodiment, the text messaging processor is further adapted to verify that the message conforms to a predetermined format. In another embodiment, the text messaging processor is further adapted to authenticate the message prior to passing the current termination number to the request processor. In yet another embodiment, the text messaging processor is further adapted to retrieve sending device identification information from the Short Message Service message, and compare the device identification information with information identifying registered communications devices to authenticate the message and to identify the DID number.

### BRIEF DESCRIPTION OF THE DRAWINGS

Further features and advantages of the present invention will become apparent from the following detailed description, taken in combination with the appended drawings, in which:

FIG. 1 is a block diagram schematically illustrating principal components of a system in which the invention may be deployed;

FIG. 2 is a flow chart illustrating principal steps involved in providing an incoming call termination service in accordance with the invention;

FIG. 3 is a flow chart illustrating principal steps in handling a call in accordance with the invention; and

FIG. 4 is a call flow diagram illustrating a connection established in accordance with the invention,

It will be noted that throughout the appended drawings, like features are identified by like reference numerals.

### DETAILED DESCRIPTION OF THE PREFERRED EMBODIMENT

The invention provides a system and method for controlling incoming call routing. It permits a telephone service user to use a text message to change a termination (telephone) number to route incoming calls to a call termination device at which the telephone service user intends to receive incoming calls. This is particularly useful for radio telephone users when roaming, and or when using a calling plan that provides a limited number of minutes of usage time.

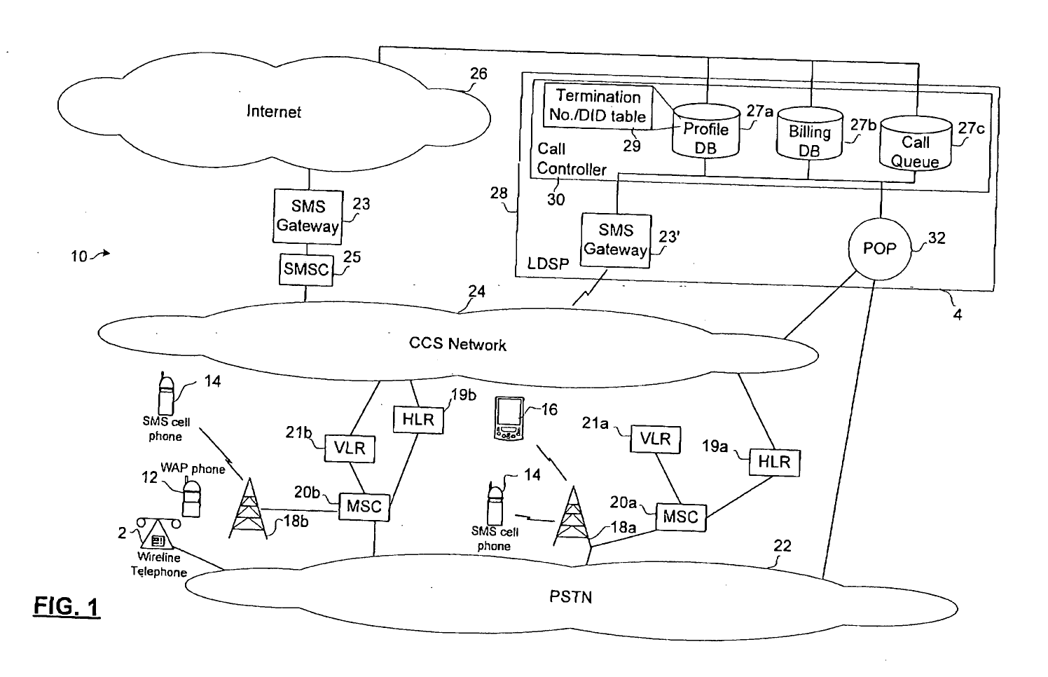

FIG. 1 schematically illustrates principal components of a system 10 in which the invention may be deployed. The system 10 includes a plurality of mobile telephone communications devices, as well as other wireless and wireline telephone terminals. The mobile telephone communications devices include wireless application protocol (WAP) telephones 12, Short Message Service (SMS)-enabled telephones 14, and portable communications devices 16 that feature telephony capabilities. As is well known in the art, such mobile communications devices are in wireless communication with mobile switching centers (MSC) 20a,b through respective transceivers 16a,b. The MSCs 20a,b access home location registers 19a,b (HLRs) and visiting location registers 21a,b (VLRs) to provide control and hand-off of calls in progress, etc.

Today's public switched telephone network (PSTN) 22 is an aggregation of bearer networks that support control signaling. Overlaying much of the PSTN 22 is a common channel signaling (CCS) network 24, which, in North America, is almost uniformly a Signaling System 7 (SS7) network. MSCs 20a,b are usually connected to the CCS network 24 for call control signaling purposes, and to the PSTN 22 for trunking purposes. As is well known in the art, call control signaling is messaging used to establish, maintain and tear down trunk connections between switches in the PSTN 22; whereas the trunk connections serve to transport voice and data between end points of established telephone calls.

MSCs 20a,b are also increasingly being used to support a plurality of Internet-related services. The connections to the CCS network 24 therefore provide a number of wireline and wireless gateways, to the Internet 26. Short Message Service (SMS) is a standard format for enabling short text messages between mobile communications devices, and can enable access to the Internet 26. Most wireline SMS gateways 23 are associated with one SMS controller 25 (SMSC) that inspects non-voice data and routes it to an associated SMS gateway, in a manner well known in the art.

Of more particular importance to the invention, a long distance service provider (LDSP) 28, which provides termination control for calls, includes a call controller 30 in communications with a point of presence (POP) 32. The POP 32 is a switch in the PSTN 22 that may be connected to the CCS network 24, but does not necessarily serve any subscriber lines. Such POPs 32 are well known in the art and serve as access points to long distance telephone networks.

The LDSPs 28 are commonly equipped with call controllers 30 that perform call processing, databases for billing 27b and queuing calls 27c, and a customer database 27a, which may include customer profile information. In accordance with the invention, the profile database 21a is further adapted to provide non-volatile storage of a termination number associated with a direct inward dial (DID) number, so that each subscriber to the service in accordance with the present invention is identified by a dialable number (preferably a DID number), and calls to the dialable (DID) number of a subscriber, are directed to a current termination number. In accordance with the illustrated embodiment, the relationship between the termination number and dialable (e.g. DID) number is stored in a table called the termination number/DID table 29.

The LDSP 28 is preferably provisioned to provide a direct connection to the SMS-enabled part of the CCS network 24 via a wireless gateway 23′ so that users of any short text message service-enabled communications device can send updates to change the current termination number associated therewith. A world-wide web interface is also supported by the LDSP 28, and is used for account inquiries and updates, changing profile information, etc. In accordance with other embodiments of the invention, the world-wide web interface may be adapted to receive change of termination number messages.

Accordingly the LDSP 28 provides an apparatus for updating a termination number used by call control equipment that serves as a termination for the subscriber's telephone number. The LDSP 28 provides a (request) processor for receiving queries from the POP 32, and returning a termination number associated with the dialable number included in the query. The LDSP 28 also includes a text messaging processor that receives change of termination number messages from subscribers. Each change of termination number message is associated with a respective dialable number. The change of termination number messages is sent via a text messaging service. The text messaging processor parses each change of termination number message to extract a current termination number, and updates a record in the termination no./DID table associated with the identified subscriber. The text messaging processor preferably also authenticates and validates a format of the change of termination number messages.

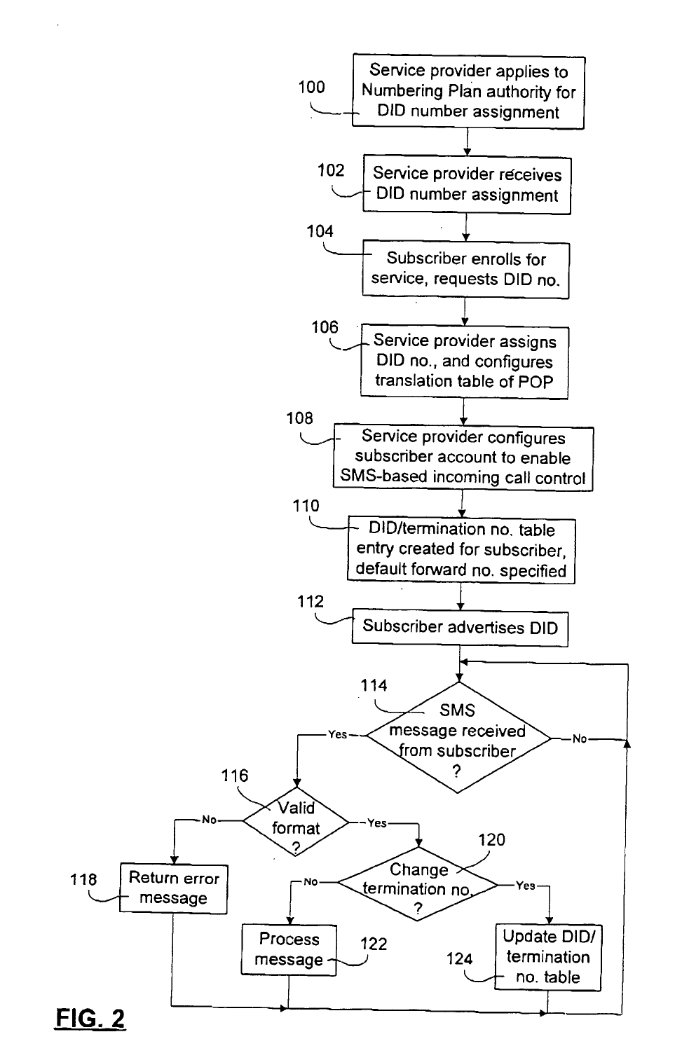

FIG. 2 illustrates steps for providing a call termination control service at an existing LDSP 28. In step 100, the service provider procures direct inward dial (DID) number assignments. For example, in North America, this may require application to the North American Numbering Plan (NANP) authority which is responsible for telephone number reservation. The DID numbers are routinely assigned to centrex, and private branch exchange (PBX) users so that the managers of the centrex and PBX can assign and reassign the DID telephone numbers, etc. However, in accordance with the invention, the DID numbers are used only to provide flexible call control termination. Non-DID numbers may also be used, so long as they are identifiable by the service provider as requiring special processing and are routed through the PSTN 22 to the service provider's POP 32. The POP 32 normally does not terminate any subscriber lines, and therefore has no means for directly terminating calls addressed to the DID numbers.

Subscribers enroll for the incoming call control service (step 104), thereby requesting one or more DID number(s). A DID number is assigned to a subscriber and the service provider configures a translation table of the POP 32 to halt translation of the DID number, and query the database 27a to determine a current termination number associated with the DID number (step 106). The service provider then updates the subscriber account (step 108) to enable incoming call control. The short text message-enabled mobile communications device(s) that may be used to issue change of termination number messages may be registered, and/or a password, or secret encoding format may be provided to the subscriber to authenticate each change of termination request. Security precautions may be important for preventing a DID number from being co-opted by other interests. The subscriber is provided with instructions as to how to change the termination number, and generally how to modify any features provided in relation to the account using text messages, the Internet, and/or dial-up telephone service.

The subscriber, in step 110, initializes the account by providing a default termination number (for example, a number associated with a mobile telephone), accepting terms and conditions, etc. After the account is modified, the service provision can begin. The subscriber receives the DID number. The subscriber then advertises the DID as their dialable telephone number. In accordance with the invention, the dialable number serves as a universal number for the subscriber and can provide enhanced privacy and security, because callers cannot determine a location of the subscriber, and only the service provider need have any access to the street address, etc. used for billing purposes. Other advantages include that the DID number may be retained seamlessly when mobile telephone, residential, work and any other directory number retained by the subscriber are changed. It is therefore economic for the subscriber to advertise the number and many problems associated with number portability, privacy and “follow-me” mobility are overcome.

When the subscriber wishes to be reached at a local telephone, rather than their mobile telephone (or whatever device is associated with the current termination number) the subscriber simply sends a text message to the service provider. It should be noted that particular advantages of the present invention include savings for the mobile telephone/communications device user. In particular, to avoid roaming charges, the mobile telephone can be turned off when in another city, and calls can be directed to a local wireline telephone. Further, if the subscriber is a mobile telephone user and has a limited amount of “free” air time in accordance with a mobile telephone service package purchased from a mobile communications provider, the subscriber can have calls routed to his/her current location, e.g. home, work, or anywhere a telephone service termination device is available (even a public pay phone), to avoid incurring charges for time in excess of the limited number of available minutes.

When a change of termination number text message is received at the LDSP 28 (as determined in step 114), it is parsed to determine if the message is authentic, and of a predefined format. For example, the originating text message-enabled device's identification information may be compared with a list of registered device identifiers, or a format, password or encoding may be used to authenticate the text message. Then the parsed message is tested to determine if the message conforms to one of a plurality of predefined formats. If the message is not recognized, or not authenticated, (as determined in step 116) a reply mechanism associated with the text message may be used, or a reply message in any format, may be returned to the subscriber (step 118), indicating the failure of the message. In some embodiments further information regarding the specific error or the predefined formats may also be provided.

Otherwise, the message is authenticated and verified in step 116, and it is determined if the message constitutes a change of termination number message (step 120). If the message is not a change of termination number message, it will be processed in accordance with the type of the message and relevant conditions (step 122). Otherwise the DID/termination number table 29 is updated (step 124) to effect the change. The value in the database 27a is therefore updated so that the call processing for a call that is received thereafter will direct the call to the new termination number.

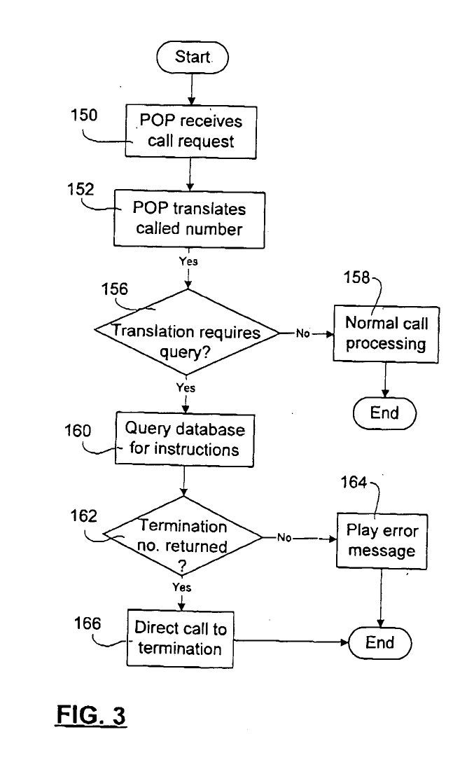

Subsequently, when calls addressed to the DID number are received at the POP 32, the process performed at the LDSP 28 includes the steps illustrated in FIG. 3. The process begins when an inbound call request (which may be an SS7-Initial Address Message (IAM)) is received from the CCS network 24 at the POP 32 (step 150). The call request indicates that a specified trunk to the POP 32 has been reserved for the call. As will be known to those skilled in the art, a call connection through the PSTN 22 is reserved between a calling party and the POP 32 at this stage in the call setup process. The called number is translated at the POP 32, in step 152. If the call request contains a called number that can be translated to determine a next switch to which to terminate the call (step 156), no further processing is required, and the translation tables are used to determine how the call should be processed, in a manner well known in the art. Thereafter normal call processing is performed (step 158).

In accordance with the present invention, the identification of calls needing further processing is enabled by the called number. If the translation table indicates that the called number requires special processing, translation may be interrupted by a parameter that indicates that a query is required. If it is determined (in step 156) that the translation requires a query, a database or other non-volatile storage is queried for instructions (in step 160). If a termination number is returned in reply to the query (step 162), the call is forwarded to the termination (in step 166). Otherwise (in step 164), an error message is played. The error message may indicate that the number dialed is not in service, or that the subscriber is not currently receiving calls, for example.

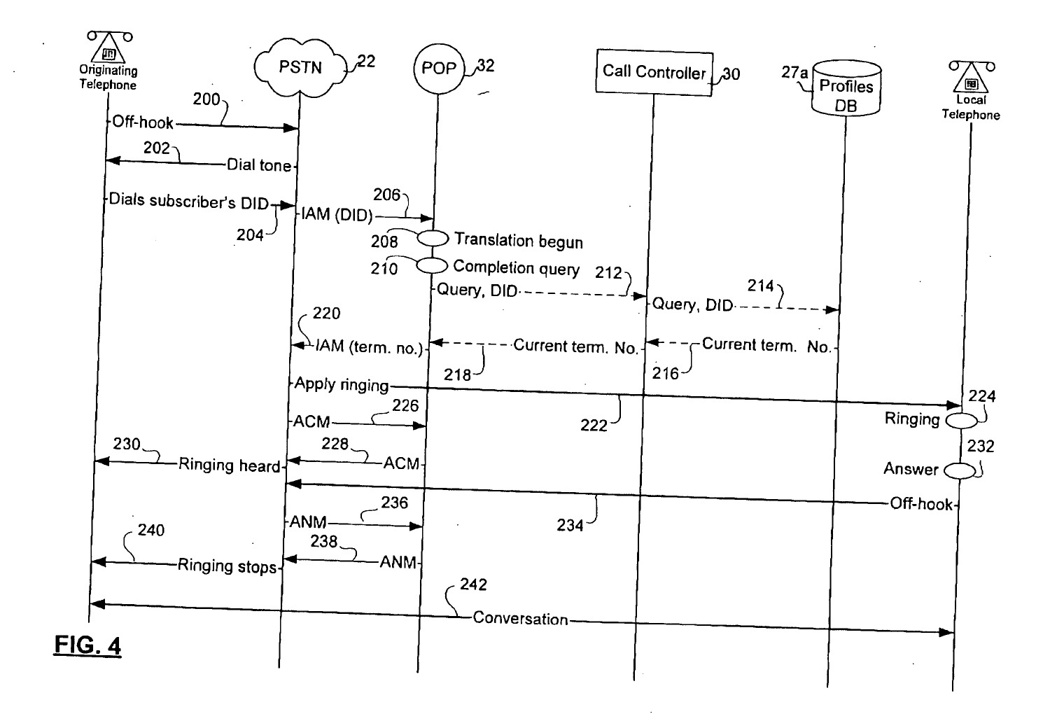

FIG. 4 is a call flow diagram illustrating how a connection may be established in accordance with the invention. In the example shown in FIG. 4, the POP 32 is connected to the CCS network 24, and uses SS7 signaling. However it should be understood that the POP 32 may alternatively use in-band signaling such as multi-frequency signaling, or the like. A calling party from an originating telephone takes the telephone off-hook (step 200). The off-hook condition is detected by a call originating switch serving the telephone, and consequently a dial tone is played (step 202). The calling party then dials the subscriber's DID number (step 204). Accordingly, an IAM is forwarded in sequence (usually over the CCS network 24) from switches of the PSTN 22 starting with the call originating switch, until the IAM is received at the POP 32 (step 206). The POP 32 begins translation of the DID number (step 208), and finds a parameter indicating that a query to the call controller 30 is required (step 210). The POP 32 therefore issues a completion query to the call controller 30 via a data network (step 212).

The query includes the DID number and is relayed (step 214) to the profiles database 27a (FIG. 1), where the DID is used as an index to access the current termination number. In alternative embodiments, the call controller 32 uses the DID to obtain an identifier of the corresponding subscriber, which is in turn used to access the current termination number of the subscriber. In a further embodiment, the POP 32 queries the database 27a directly and receives a direct response. The termination number is returned to the POP 32 (step 218) via the call controller 30 (step 216). The call controller 30 instructs the POP 32 to direct the call to the termination number supplied, which the POP 32 accomplishes by formulating an IAM addressed to the termination number (step 220). Of course the termination number was translated at the FOP 32 to determine a trunk to reserve, and a next switch in the PSTN 22 to which to forward the IAM. The IAM is forwarded hop-by-hop through the PSTN 22 until it reaches a call terminating switch that serves the termination number. The call terminating switch may be a standard PSTN switch, generally called a service switching point (SSP), an MSC 20 if the termination number is a mobile device, a centrex or PBX system, in which case the termination number may also be another DID number, or an IP device accessed through an IP gateway in a manner known in the art. The call termination switch determines that the telephone set associated with the termination number is on-hook. Accordingly the call termination switch applies ringing to the subscriber line (step 222), which activates a ringing tone at the called telephone (step 224), and returns an address complete message (ACM) through the PSTN 22, in a manner well known in the art (step 226). As will be appreciated by those skilled in the art, the ACM is relayed hop-by-hop through the call connection so that the reserved trunk resources are “nailed up”, In step 226 the ACM arrives at the POP 32, and in step 228, it is returned back through the PSTN 22 toward the originating switch. The originating switch receives the ACM and completes the connection so that the ringing is heard by the calling party (step 230).

In step 232, the subscriber answers the called telephone by taking the telephone off-hook. This is detected by the call termination switch (step 234), and a cascade of answer messages (ANMs) is returned in much the same manner as the ACMs before them. In step 236 the ANM is forwarded to the POP 32. In step 238, it is forwarded back to a previous switch in the call connection, and in step 240 the call originating switch receives the ANM. In step 242, the connection is live, and conversation begins between the calling party and the subscriber.

Accordingly, a method and system for updating a termination number associated with a subscriber is provided and a novel method for effecting an incoming call routing service from a point of presence in the PSTN is enabled. As noted above, the invention provides many advantages over the known prior art. It enables a subscriber to advertise a single number that may be used to access the subscriber regardless of the subscriber's location or choice of call termination device. It also permits the subscriber to effectively and efficiently control telephone communications costs by selectively directing calls to the most convenient and/or cost-effective call termination device. Thus mobile inbound long distance and roaming charges can be reduced. It also enhances subscriber privacy and disassociates the subscriber from telephone numbers that can be traced through public switched telephone network facilities.

Although the invention has been described with specific reference to Short Message Service (SMS) facilities, it will be understood by persons skilled in the art that any other text messaging service, including email, can also be used to send telephone termination change messages. The text message service that is used is a matter of design choice, and more than one interface may be provided to service subscribers to permit them to change their current termination number.

Although the invention has also been described with specific reference to the public switched telephone network, persons skilled in the art will understand that the call termination number may be an Internet Protocol (IP) termination number, or any other termination number that can be accessed through an appropriate gateway.

The embodiments of the invention described above are therefore intended to be exemplary only, and the scope of the invention is intended to be limited solely by the scope of the appended claims.

1. A method for updating a termination number used by call control equipment to direct incoming calls addressed to a dialable telephone number, comprising:
receiving a change of termination number message from a subscriber sent via a text message service;
parsing the message to extract the termination number; and
associating the termination number with the dialable telephone number in a format retrievable by a point of presence that serves the dialable telephone number.

2. The method as claimed in claim 1 wherein the receiving comprises receiving a Short Message Service (SMS) message containing the change of termination number message.

3. The method as claimed in claim 1 further comprising verifying that the message conforms to a predetermined format.

4. The method as claimed in claim 3 wherein the verifying further comprises returning an error message to the identified subscriber if the message does not conform to the predetermined format.

5. The method as claimed in claim 1 further comprising authenticating the message prior to associating the termination number with the dialable number.

6. The method as claimed in claim 2 wherein the authenticating comprises comparing origination station information automatically supplied by the text message service with a list of registered device identifiers.

7. The method as claimed in claim 2 further comprising including a security measure in the change of termination number message.

8. The method as claimed in claim 1 wherein the dialable telephone number is a direct-inward-dial (DID) number served by call control equipment operated by a service provider who provides the call termination service to the subscriber.

9. The method as claimed in claim 1 wherein the associating comprises saving the termination number in a database so that the termination number is uniquely associated with the dialable number.

10. A method for changing a termination number associated with a direct inward dial (DID) number, comprising:
formulating a change of termination number message using a text messaging service in accordance with a format specified by an incoming call control service provider, the message identifying a termination number to which incoming calls to the DID are to be directed; and
sending the change of termination number message to the service provider, which uses the message to update a table so that a point of presence that queries the table using the DID number returns the termination number to which the service provider may direct a call.

11. The method as claimed in claim 10 wherein the formulating comprises formulating a Short Message Service (SMS) message.

12. The method as claimed in claim 10 further comprising selecting the termination number from among call termination devices available to receive calls at a current location of a subscriber to the service.

13. A method of permitting a text message-enabled mobile communications device user to reduce mobile telephone roaming charges, comprising:
providing the user with a registered direct inward dial (DID) number;
configuring call control equipment that is designated to serve the DID number in a public telephone network, to:
receive calls addressed to the DID number;
query a database to determine a current termination number associated with the DID number;
direct completion of the calls to the current termination number; and
providing a text message interface through which the user can update the database using a message sent from the mobile communications device.

14. The method as claimed in claim 13 wherein configuring the call control equipment comprises configuring a point of presence (POP) in the public switched telephone network.

15. The method as claimed in claim 14 wherein configuring the POP comprises inserting into a translation table of the POP a parameter that prompts a query to retrieve the termination number from the database.

16. The method as claimed in claim 15 wherein providing a text message interface comprises providing a Short Message Service (SMS) gateway between the call controller and a Short Message Service network.

17. A method of providing incoming call control to a text message-enabled communications device user, the method comprising:
providing the user with a registered direct inward dial (DID) number;
configuring call control equipment that is designated to serve the DID number in a public telephone network to:
receive calls addressed to the DID number;
query a database to determine a current termination number associated with the DID number; and
direct completion of the calls to the current termination number; and
providing a text message interface through which the user can update the database using the communications device.

18. The method as claimed in claim 17 wherein configuring the call control equipment comprises configuring a point of presence (POP) in the public switched telephone network.

19. The method as claimed in claim 18 wherein configuring the POP comprises inserting into a translation table of the POP a parameter that prompts a query to retrieve the termination number from the database.

20. The method as claimed in claim 19 wherein providing a text message interface comprises providing a Short Message Service (SMS) gateway.

21. An apparatus for updating a termination number used by call control equipment that serves a direct inward dial (DID) number, the apparatus comprising:
a request processor for receiving a DID number from the call control equipment, and returning a termination number associated with the DID number; and
a text messaging processor for:
receiving a change of termination number message from an identified subscriber device associated with the DID number;
parsing the message to extract a current termination number to be associated with the DID number; and
passing the current termination number to the request processor, which associates the current termination number with the DID number.

22. An apparatus as claimed in claim 21 wherein the text messaging processor further verifies that the message conforms to a predefined format.

23. An apparatus as claimed in claim 21 wherein the text messaging processor further authenticates the message prior to passing the current termination number to the request processor.

24. An apparatus as claimed in claim 23 wherein the text messaging processor retrieves sending device identification information from a Short Message Service (SMS) message, and compares the device identification information with information identifying registered communications devices to authenticate the message and to identify the DID number.

25. An apparatus as claimed in claim 21 wherein the call control equipment comprises a point of presence in a switched telephone network.
